(19) United States
(12) Patent Application Publication
(10) Pub. No.: US 2021/0192960 A1
(43) Pub. Date: Jun. 24, 2021

(54) ON-BOARD CONTROL UNITS, MOTOR VEHICLES AND METHOD FOR OPERATING ON-BOARD CONTROL UNITS FOR TIME-SYNCHRONIZED BRAKING

(71) Applicant: Robert Bosch GmbH, Stuttgart (DE)

(72) Inventors: Klaus Sambale, Oberhausen (DE); Nadia Brahmi, Hildesheim (DE)

(21) Appl. No.: 17/272,806

(22) PCT Filed: Aug. 26, 2019
(86) PCT No.: PCT/EP2019/072677

§ 371 Date: Mar. 2, 2021

(30) Foreign Application Priority Data
Sep. 4, 2018 (DE) 10 2018 215 027.3

(51) Int. Cl. G08G 1/00; H04L 29/08; G08G 1/16; H04W 4/46

(52) U.S. Cl. CPC G08G 1/22; H04W 4/46; G08G 1/162; H04L 67/12

(57) ABSTRACT

A method is provided for operating a first on-board control unit for a first motor vehicle of a group of motor vehicles. The method includes: ascertaining a braking point in time for a time-synchronized brake application of at least a portion of the motor vehicles of the group, sending a message indicating the braking point in time in the direction of a second control unit of a second motor vehicle, selecting the ascertained braking point in time as a valid braking point in time, and initiating a brake application of the first motor vehicle only when the valid braking point in time is reached.

### FIELD

The present invention relates to a first on-board control unit, to a first motor vehicle, to a method for operating a first on-board control unit, to a second on-board control unit, to a second motor vehicle and to a method for operating a second on-board control unit.

### SUMMARY

A first aspect of the present invention relates to an on-board control unit for a first motor vehicle of a group of motor vehicles. In accordance with an example embodiment of the present invention, the first on-board control unit include at least one processor, at least one memory including computer program code, at least one communication module and at least one antenna, the computer program code being configured in such a way that it, including the at least one processor, the at least one communication module and the at least one antenna, ensures that the first on-board control unit ascertains a braking point in time for a time-synchronized brake application of at least a portion of the motor vehicles of the group, sends a message indicating the braking point in time in the direction of a second control unit of a second motor vehicle, selects the ascertained braking point in time as a valid braking point in time, and initiates a brake application of the first motor vehicle only when the valid braking point in time is reached.

The time-synchronized brake application advantageously results in the entire group of motor vehicles or a portion thereof being transferred to a safe state, i.e., a standing state. In the event of a disruption in communication or an intentional brake application of the group of motor vehicle, no further messages are received and the brake application is initiated at the instantaneous valid braking point in time, with which the motor vehicles driving in a line automatically carry out an emergency brake application. The following vehicle is thus prevented from rear-ending the first motor vehicle. The wait until the braking point in time occurs in fact increases the actual braking distance. On the other hand, it is possible that as a result of the time-synchronized initiation of the brake application, in particular of an emergency brake application, the distance between the motor vehicles driving in line may be further reduced. This is possible, since reaction time of the control unit or of the driver must be factored in less or not at all when ascertaining and maintaining the distance to the preceding vehicle. Instead, the reduction of the distance creates a gain in slipstream, which is accompanied by reduced fuel consumption for the following motor vehicles. As a result, an advantageous compromise is provided between increased braking distance and a reduction in the distance between the motor vehicles while simultaneously ensuring emergency brake application potential.

In one advantageous specific example embodiment of the present invention, the first on-board control unit ascertains one further braking point in time for the time-synchronized brake application of at least a portion of the motor vehicles of the group, the further braking point in time lying further in the future than the previously ascertained braking point in time, sends a further message indicating the further braking point in time in the direction of the second control unit, and selects the ascertained further braking point in time as a valid braking point in time. The valid braking point in time is thus advantageously postponed into the future and no brake application is initiated. By repeating these steps, the group of motor vehicles or control units is continually provided by the first control unit with new braking points in time in order to prevent the brake application of the entire group of motor vehicles as long as messages including new braking points in time are present.

In one advantageous specific embodiment of the present invention, the first on-board control unit ascertains a brake indication for inducing a brake application and, as a function of the ascertainment of the brake indication, refrains from sending messages that indicate a further braking point in time. By refraining from sending further messages that include a respective braking point in time, the valid braking point in time is no longer extended and the synchronous brake application of the group of motor vehicles is carried out upon reaching the valid braking point in time.

One further aspect of the present invention relates to a first motor vehicle including the first on-board control unit according to one of the above-described aspects and including a first braking system, the first on-board control unit carrying out the brake application of the first motor vehicle with the aid of the first braking system.

One further aspect of the present invention relates to a method for operating a first on-board control unit for a radio communication network and for a first motor vehicle of a group of motor vehicles. In accordance with an example embodiment of the present invention, the method includes: ascertaining a braking point in time for a time-synchronized brake application of at least a portion of the motor vehicles of the group, sending a message indicating the braking point in time in the direction of a second control unit, selecting the ascertained braking point in time as a valid braking point in time, and initiating a brake application of the first motor vehicle only when the valid braking point in time is reached.

One further aspect of the present invention relates to a second on-board control unit for a second motor vehicle. In accordance with an example embodiment of the present invention, the second on-board control unit includes at least one processor, at least one memory including computer program code, at least one communication module and at least one antenna, the computer program code being configured in such a way that it, including the at least one processor, the at least one communication module and the at least one antenna, ensures that the second on-board control unit receives a message originating from a first on-board control unit, which indicates a braking point in time for a time-synchronized brake application of at least a portion of the motor vehicles of the group, selects the received braking point in time as a valid braking point in time, and initiates a brake application of the second motor vehicle only when the valid braking point in time is reached.

The synchronized brake application advantageously results in the entire group of motor vehicles or a portion thereof being transferred to a safe state, i.e., a standing state. In the event of a disruption in communication or of an intentional brake application of the group of motor vehicle, no further messages are received and the brake application is initiated at the instantaneous valid braking point in time, with which the motor vehicles driving in line automatically carry out an emergency brake application. The following vehicle is thus prevented from rear-ending the first motor vehicle. The wait until the braking point in time occurs in fact increases the actual braking distance. On the other hand, it is possible that as a result of the time-synchronized initiation of the brake application, in particular of an emergency brake application, the distance between the motor vehicles when driving in line may be further reduced. This is possible, since reaction time of the control unit or of the driver must be factored in less or not at all when ascertaining and maintaining the distance to the preceding vehicle. Instead, the reduction of the distance creates a gain in slipstream, which is accompanied by reduced fuel consumption for the following motor vehicles. As a result, an advantageous compromise is provided between increased braking distance and a reduction in the distance between the motor vehicles while simultaneously ensuring emergency brake application potential.

In one advantageous specific embodiment of the present invention, the second on-board control unit receives a further message from the first control unit, which indicates a further braking point in time for the time-synchronized brake application of at least a portion of the motor vehicles of the group, the further braking point in time lying further in the future than the previously received braking point in time, and selects the received further braking point in time as the valid braking point in time. The valid braking point in time is thus advantageously postponed into the future and no brake application is initiated. By repeating these steps, the group of motor vehicles or control units is continually provided by the first control unit with new braking points in time in order to prevent the brake application of the entire group of motor vehicles as long as messages including new braking points in time are present.

In one advantageous specific embodiment of the present invention, the second on-board control unit sends another message indicating the received braking point in time in the direction of a third on-board control unit. By sending the other message that includes the braking point in time, a hop-by-hop method is advantageously implemented, in which each control unit knows its position in the platoon/in the line and, starting from the preceding first motor vehicle, sends each braking point in time received by the immediately preceding motor vehicle to the immediately following motor vehicle. Each following motor vehicle or its control unit may also refrain from forwarding the received braking points in time in order to thereby achieve a brake application of the motor vehicles following behind.

One further aspect of the present invention relates to a second motor vehicle including the second on-board control unit according to one of the preceding aspects and including a second braking system, the second on-board control unit carrying out the brake application of the second motor vehicle with the aid of the second braking system.

One further aspect of the present invention relates to a method for operating a second on-board control unit for a radio communication network and for a second motor vehicle of a group of motor vehicles. In accordance with an example embodiment of the present invention, the method includes: receiving a message originating from a first on-board control unit, which indicates a braking point in time for a time-synchronized brake application of at least a portion of the motor vehicles of the group, selecting the received braking point in time as the valid braking point in time, and initiating a brake application of the second motor vehicle only when the valid braking point in time is reached.

### BRIEF DESCRIPTION OF THE DRAWINGS

Further features and advantages of the present invention are derivable from the description below and from the figures.

FIG. 1 shows a traffic situation in a schematic, perspective view, in accordance with an example embodiment of the present invention.

FIGS. 2 through 4 each schematically show a sequence diagram for operating a radio communication network, in accordance with example embodiments of the present invention.

### DETAILED DESCRIPTION OF EXAMPLE EMBODIMENTS

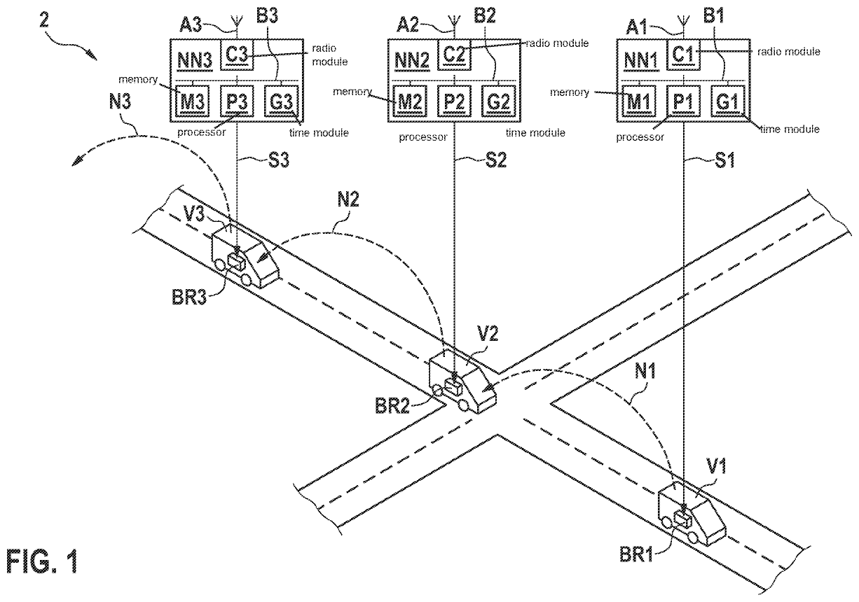

FIG. 1 schematically shows a perspective view of an exemplary traffic situation. Each motor vehicle V1, V2, V3 includes an on-board control unit NN1, NN2, NN3, which together form a radio communication network. Respective motor vehicle V1, V2, V3 is, in particular, a truck or a truck and trailer or semitrailer truck.

Each of control units NN1, NN2, NN3 includes a data bus B1, B2, B3, which interconnects at least one processor P1, P1, P3, one memory M1, M2, M3 and one radio module C1, C2, C3. At least one antenna A1, A2, A3 is connected to radio module C1, C2, C3. Respective radio module C1, C2, C3 is configured to transmit and receive radio signals according to ad hoc radio communication network 2 via antenna A1, A2, A3. A computer program in the form of a computer program product is stored on memory M1, M2, M3.

The computer program is designed to carry out the method steps outlined in this description, in particular, with the aid of the at least one processor P1, P2, P3, of the at least one memory M1, M2, M3 and of the at least one radio module C1, C2, C3, and to communicate with further control units via the at least one antenna A1, A2, A3. Alternatively or in addition, processors P1, P2, P3 are implemented as ASICs in order to carry out the described method steps. Respective control unit NN1, NN2, NN3 includes a time module G1, G2, G3, with the aid of which respective control unit NN1, NN2, NN3 synchronizes its internal clock to a global time. Time module G1, G2, G3 is, for example, a GPS module (GPS: Global Positioning System). This internal clock synchronized to the global time is utilized to coordinate the actions of on-board control units NN1 through NN3. Respective motor vehicle V1, V2, V3 includes a braking system BR1, BR2, BR3. Respective control unit NN1, NN2, NN3 initiates a brake application, in particular an emergency brake application, with the aid of a signal S1, S2, S3, signal S1, S2, S3 being transmitted to respective braking system BR1, BR2, BR3. Respective control unit NN1, NN2, NN3 in one exemplary embodiment is made up of multiple individual components—such as, for example, a radio communication network terminal and a control unit, which in turn include at least one processor, one memory, one data bus and at least one communication interface. The terminal receives and transmits control messages, for example, the pieces of information contained in the control messages being processed by the at least one control unit, the at least one control unit ascertaining signal S1.

Radio communication network 2 provides, for example, at least one ad hoc radio channel in the form of radio resources or radio operation means. Each of control units NN1, NN2, NN3 is configured, for example, according to the Standard IEEE 802.11p, in particular, IEEE 802.11p-2010 of Jul. 15, 2010, which is incorporated herein by reference in this description. The IEEE 802.11p PHY and MAC functions provide services for protocols of the upper layer for dedicated short range communication, DSRC in the U.S. and for cooperative ITS, C-ITS, in Europe. Control units NN1, NN2, NN3 communicate directly with one another via the ad hoc radio channel in the non-licensed frequency range. The ad hoc radio channel is accessed by radio modules C1, C2, C3 with the aid of a CSMA/CA protocol (Carrier Sense Multiple Access/Collision Avoidance). The ad hoc radio channel and radio communication network 2 are specified, for example, by the IEEE Standard “802.11p-2010—IEEE Standard for Information Technology—Local and Metropolitan Area Networks-” Specific Part 11: Wireless LAN Medium Access Control (MAC) and Physical Layer (PHY) Specifications Amendment 6: Wireless Access in Vehicular Environments,” which is incorporated by reference. IEEE 802.11p is a standard for expanding the WLAN Standard IEEE 802.11. The aim of IEEE 802.11p is to establish radio technology in passenger vehicles and to provide a reliable interface for Intelligent Transport Systems (ITS) applications. IEEE 802.11p is also the basis for Dedicated Short Range Communication (DSRC) in the range from 5.85 GHz through 5.925 GHz. On-board control units NN1, NN2, NN3 alternatively form a communication network according to the LTE-V Standard or another standard. In order to access the ad hoc radio channel, control units NN1, NN2, NN3 apply, for example, a Listen-Before-Talk method. The LBT includes a back-off procedure, which checks before transmitting on the ad hoc radio channel whether the latter is occupied.

The document “ETSI EN 302 663 V1.2.0 (2012.11),” which is incorporated by reference herein, describes the two lowermost layers of the ITS-G5 technology (ITS G5: Intelligent Transport Systems, which operate in the 5 GHz frequency band), the physical layer and the data security layer. Radio modules C1, C2, C3 implement, for example, these two lowermost layers and corresponding functions according to “ETSI TS 102 687 V1.1.1 (2011-07)” in order to use the ad hoc radio channel. The following non-licensed frequency bands are available in Europe for the use of the ad hoc radio channel, which is part of the non-licensed frequency band NLFB: 1) ITS-G5A for safety-relevant applications in the frequency range 5.875 GHz through 5.905 GHz; 2) ITS-G5B for non-safety-relevant applications in the frequency band 5.855 GHz through 5.875 GHz; and 3) ITS-G5D for the operation of ITS applications in the frequency range 5.055 GHz through 5.925 GHz. ITS-G5 enables the communication between control units NN1, NN2, NN3 outside the context of a base station. The Standard ITS-G5 enables the immediate exchange of data frames and avoids the effort that is required in the construction of a cell-based network.

The document “ETSI TS 102 687 V1.1.1 (2011-07),” which is incorporated by reference herein, describes for ITS-G5 a “Decentralized Congestion Control Mechanism.” The ad hoc radio channel is used, among other things, for exchanging traffic safety data and traffic efficiency data. Radio modules C1, C2, C3 implement, for example, the functions as they are described in the document “ETSI TS 102 687 V1.1.1 (2011-07).” The applications and services of ITS-G5 are based on the cooperative behavior of control units NN1, NN2, NN3, which form radio communication network 2. Radio communication network 2 enables time-critical applications in traffic, which require a rapid exchange of information in order to alert and to support the driver and/or the vehicle in a timely manner. In order to ensure the smooth functioning of radio communication network 2, “Decentral Congestion Control” (DCC) is used for the ad hoc radio channel by ITS-G5. DCC has functions that are located on multiple layers of the ITS architecture. The DCC mechanisms are based on knowledge about the radio channel. The channel state information is obtained via channel probing.

In the traffic situation shown, vehicle V1 is traveling ahead of vehicle V2 and vehicle V2 is traveling ahead of vehicle V3. Vehicles V1 through V3 form a line, a so-called platoon. Motor vehicles V2 and V3 adapt their respective distance to preceding motor vehicle V1 and V2 in order to be able to carry out an emergency brake application without rear-ending the preceding motor vehicle.

In the example shown, a respectively signed control message N1, N2, N3 by control unit NN1, NN2, NN3 is sent to control unit NN2, NN3 of the immediately following motor vehicle, control unit NN2, NN3 checking the origin of the control message based on a contained signature. In one refinement, an encryption of control message N1, N2, N3 is provided, for example, including a group key, so that the motor vehicles of the group have access to control message N1, N2, N3.

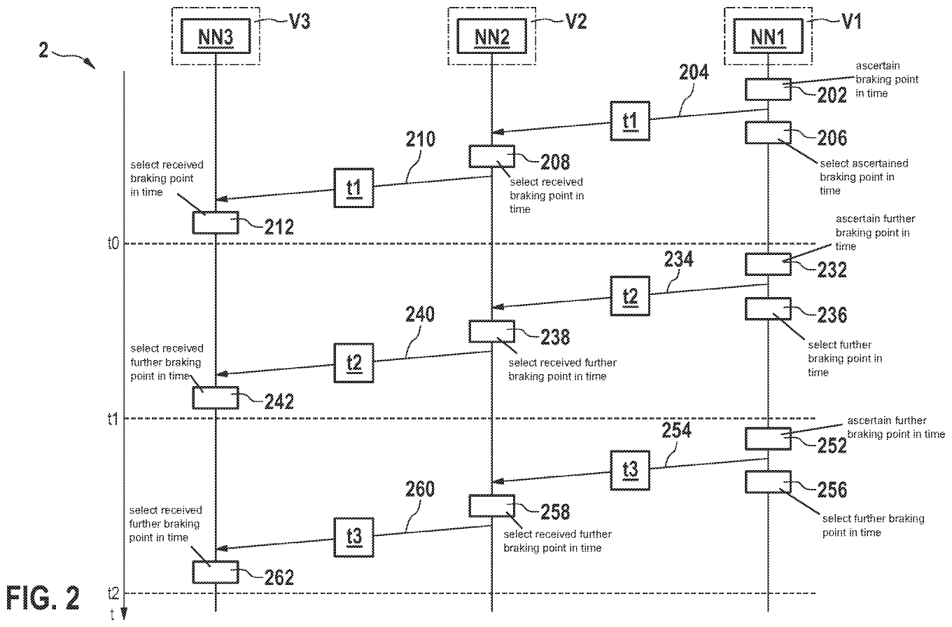

FIG. 2 schematically shows a sequence diagram for operating radio communication network 2. First on-board control unit NN1 ascertains in a step 202 a braking point in time t1, which is transmitted in a step 204 to control unit NN2. In a step 206, control unit NN1 selects ascertained braking point in time t1 as the valid braking point in time.

In a step 208, control unit NN2 selects received braking point in time t1 as the valid braking point in time. In a step 210, received braking point in time t1 is transmitted to control unit NN3. Control unit NN3 selects received braking point in time t1 in a step 212 as the valid braking point in time.

Before valid braking point in time t1 occurs, a brake application in the form of an emergency brake application is carried out by none of control units NN1 through NN3. Thus, a previously ascertained or received braking point in time t0 loses its validity for initiating a brake application in the form of an emergency brake application when braking point in time t0 occurs.

In order not to further initiate any emergency brake application, it is necessary to replace valid braking point in time t1 with a further braking point in time t2, which lies further in the future than braking point in time t1. As a result, this further braking point in time t2 must be distributed to control units NN1 through NN3 in radio communication network 2 even before braking point in time t1 occurs. For this purpose, control unit NN1, which leads the platoon, ascertains in a step 232 further braking point in time t3 and transmits the latter in a step 234 to control unit NN2.

In a step 236, first control unit NN1 selects ascertained braking point in time t2 as the valid braking point in time, with which braking point in time t1 is replaced by braking point in time t2 as the valid braking point in time. In a step 238, second control unit NN2 selects received further braking point in time t2 as the valid braking point in time. In a step 240, second control unit NN2 transmits received further braking point in time t2 to third control unit NN3, which selects received braking point in time t2 in a step 242 as the valid braking point in time. Steps 252 through 262 yield similarly to steps 232 through 242 for a further braking point in time t3.

Motor vehicles NN2, NN3 update their respectively valid braking point in time only as a function of messages that originate from immediately preceding motor vehicle NN1, NN2. This ensures that in the event of a loss of communication or a disruption of communication, all vehicles behind motor vehicle NN2, NN3 synchronized at the respectively valid braking point in time may be brought to a standstill.

In one further example, the ascertained braking point in time is sent by first control unit NN1 in repeating messages to second control unit NN2, which in turn transmits the ascertained braking point in time in repeating messages to third control unit NN3. In this way, it is possible to compensate for packet losses and to prevent unnecessary emergency brake applications.

The distance between the motor vehicles in the platoon potentially reduced with this method must be increased when transitioning to another method for initiating an emergency brake application before this other method is applied. In addition, mechanisms are provided in order to ensure that the same emergency brake application method is used platoon-wide.

Braking points in time t1, t2, t3 are explicitly communicated, for example, in the message contents—for example, in the form of a time stamp. In another example, the respective message includes an identifier, which clearly references respective braking points in time t1, t2, t3.

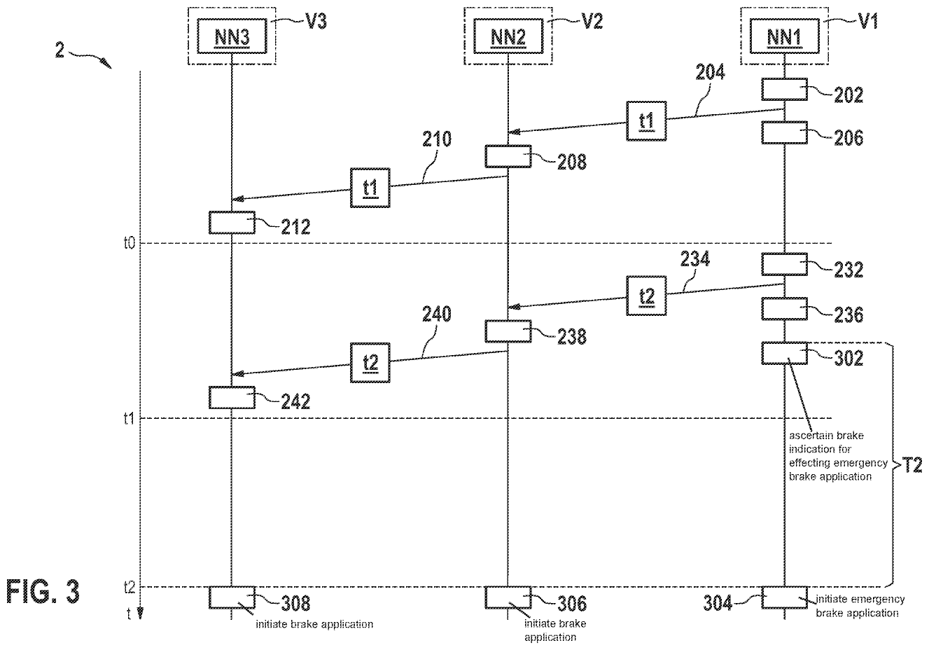

FIG. 3 schematically shows a sequence diagram for operating radio communication network 2. In contrast to FIG. 2, first control unit NN1 ascertains in a step 302 a brake indication for effecting an emergency brake application. This brake indication is ascertained, for example, as a function of a recognition of an obstacle on the roadway ahead of first motor vehicle V1. First control unit NN1 prevents further braking points in time from being sent as a function of the brake indication. In one example, further messages are immediately prevented from being sent. In another example, messages continue to be transmitted, not including new braking points in time, but including the indication that an emergency brake application is imminent. The following motor vehicle could then prepare for the brake application at the valid braking point in time and, for example, pull the seatbelt tightener more firmly into the seat in order to reduce the risk of injury during the emergency brake application.

Braking point in time t2 lastly distributed in the platoon thus becomes effective when braking point in time t2 occurs and a respective network unit of network units NN1, NN2, NN3 initiates a brake application of respective motor vehicle V1, V2, V3 in a respective step 304, 306, 308. Thus, a synchronous brake application of all motor vehicles V1, V2, V3 involved in the platoon takes place at point in time t2. To enable this, first control unit NN1 must await a time period T2 between the recognition of a necessary emergency brake application in step 302 and the actual initiation of the emergency brake application in step 304.

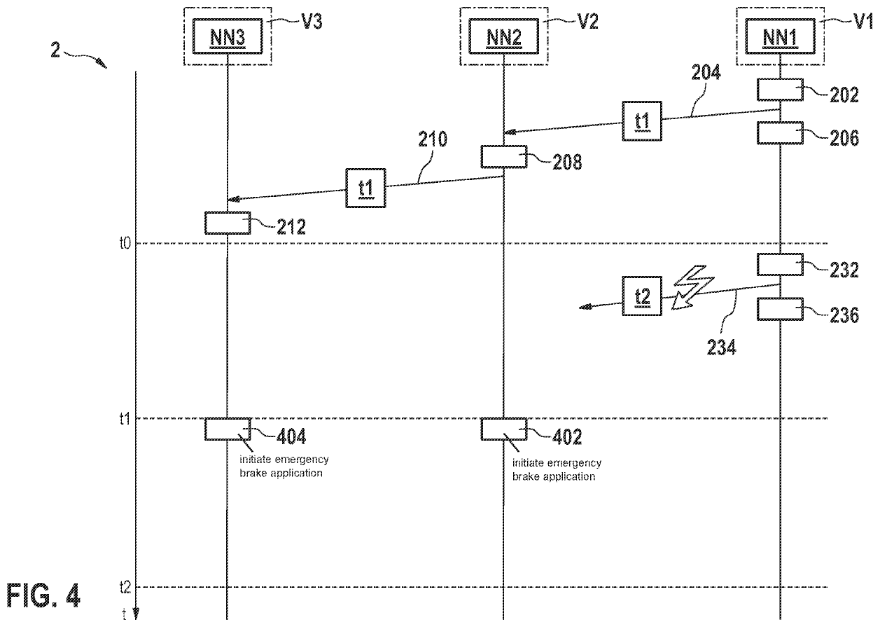

FIG. 4 schematically shows a sequence diagram for operating radio communication network 2. In contrast to FIG. 2, the communication during the transmission of further braking point in time t2 is disrupted in step 234, with which control units NN2 and NN3 do not obtain further braking point in time t2. As a result, respective control unit NN2, NN3 initiates a brake application, in particular an emergency brake application, in a step 402, 404. First motor vehicle V1 on the other hand continues further, which results in a separation of the platoon made up of motor vehicles V1 through V3.

1-10. (canceled)

11. A first on-board control unit for a first motor vehicle of a group of motor vehicles, the first on-board control unit comprising:
at least one processor;
at least one memory including computer program code;
at least one communication module; and
at least one antenna;
wherein the computer program code is configured to, along with the at least one processor, the at least one communication model and the at least one antenna, cause the first on-board control unit to:
ascertain a braking point in time for a time-synchronized brake application of at least a portion of the motor vehicles of the group;
send a message indicating the braking point in time in a direction of a second control unit of a second motor vehicle;
select the ascertained braking point in time as a valid braking point in time; and
initiate a brake application of the first motor vehicle only when the valid braking point in time is reached.

12. The first on-board control unit as recited in claim 11, wherein the first on-board control unit is configured to:
ascertain a further braking point in time for the time-synchronized brake application of at least a portion of the motor vehicles of the group, the further braking point in time lying further in the future than a previously ascertained braking point in time;
send a further message indicating the further braking point in time in the direction of the second control unit of the second motor vehicle; and
select the ascertained further braking point in time as the valid braking point in time.

13. The first on-board control unit as recited in claim 11, wherein the first on-board control unit is configured to:
ascertain a brake indication for initiating a brake application; and
refrain from sending messages indicating a further braking point in time as a function of the ascertainment of the brake indication.

14. A first motor vehicle, comprising:
a first on-board control unit, including:
at least one processor,
at least one memory including computer program code,
at least one communication module, and
at least one antenna,
wherein the computer program code is configured to, along with the at least one processor, the at least one communication model and the at least one antenna, cause the first on-board control unit to:
ascertain a braking point in time for a time-synchronized brake application of at least a portion of a group motor vehicles including the first motor vehicle,
send a message indicating the braking point in time in a direction of a second control unit of a second motor vehicle,
select the ascertained braking point in time as a valid braking point in time, and
initiate a brake application of the first motor vehicle only when the valid braking point in time is reached; and
a first braking system, wherein the first on-board control unit carries out the brake application of the first motor vehicle using the first braking system.

15. A method for operating a first on-board control unit for a first motor vehicle of a group of motor vehicles, the method comprising the following steps:
ascertaining a braking point in time for a time-synchronized brake application of at least a portion of the motor vehicles of the group;
sending a message indicating the braking point in time in a direction of a second control unit of a second motor vehicle;
selecting the ascertained braking point in time as a valid braking point in time; and
initiating a brake application of the first motor vehicle only when the valid braking point in time is reached.

16. A second on-board control unit for a second motor vehicle of a group of motor vehicles, the second on-board control unit comprising:
at least one processor;
at least one memory including computer program code;
at least one communication module; and
at least one antenna;
wherein the computer program code is configured to, along with the at least one processor, the at least one communication module and the at least one antenna, cause the second on-board control unit to:
receive a message originating from a first control unit of a first motor vehicle, which indicates a braking point in time for a time-synchronized brake application of at least a portion of the motor vehicles of the group,
select the received braking point in time as a valid braking point in time, and
initiate a brake application of the second motor vehicle only when the valid braking point in time is reached.

17. The second on-board control unit as recited in claim 16, wherein the second on-board control unit is configured to:
receive a further message originating from the first control unit, which indicates a further braking point in time for the time-synchronized brake application of at least a portion of the motor vehicles of the group, the further braking point in time lying further in the future than a previously received braking point in time, and
select the received further braking point in time as the valid braking point in time.

18. The second on-board control unit as recited in claim 17, wherein the second on-board control unit is configured to send another message indicating the further braking point in time in a direction of a third on-board control unit of a third motor vehicle.

19. A second motor vehicle, comprising:
a second on-board control unit, including:
at least one processor;
at least one memory including computer program code;
at least one communication module; and
at least one antenna;
wherein the computer program code is configured to, along with the at least one processor, the at least one communication module and the at least one antenna, cause the second on-board control unit to:
receive a message originating from a first control unit of a first motor vehicle, which indicates a braking point in time for a time-synchronized brake application of at least a portion of a group motor vehicles including the second motor vehicle,
select the received braking point in time as a valid braking point in time, and
initiate a brake application of the second motor vehicle only when the valid braking point in time is reached; and
a second braking system, wherein the second on-board control unit is configured to carry out the brake application of the second motor vehicle using the second braking system.

20. A method for operating a second on-board control unit for a second motor vehicle of a group of motor vehicles, the method comprising the following steps:
receiving a message originating from a first on-board control unit of a first motor vehicle, which indicates a braking point in time for a time-synchronized brake application of at least a portion of the motor vehicles of the group;
selecting the received braking point in time as a valid braking point in time; and
initiating a brake application of the second motor vehicle only when the valid braking point in time is reached.
